(19) United States
(12) Patent Application Publication
(10) Pub. No.: US 2025/0041937 A1
(43) Pub. Date: Feb. 6, 2025

(54) METAL POWDER FOR A POWDER BED-BASED ADDITIVE MANUFACTURING METHOD

(71) Applicant: Safran Aircraft Engines, Paris (FR)

(72) Inventors: Hugo Jean-Louis SISTACH, Moissy-Cramayel (FR); Cédric Pierre Jacques COLAS, Moissy-Cramayel (FR)

(73) Assignee: Safran Aircraft Engines, Paris (FR)

(21) Appl. No.: 18/717,320

(22) PCT Filed: Dec. 7, 2022
(86) PCT No.: PCT/FR2022/052271

§ 371 Date: Jun. 6, 2024

(30) Foreign Application Priority Data
Dec. 7, 2021 (FR) FR2113048

(51) Int. Cl. B22F 1/052; B22F 10/28; B22F 10/36; B22F 10/64; B33Y 10/00; B33Y 70/00; B33Y 80/00

(52) U.S. Cl. CPC B22F 1/052; B22F 10/28; B22F 10/36; B22F 10/64; B22F 2301/15; B22F 2304/10; B33Y 10/00; B33Y 70/00; B33Y 80/00

(57) ABSTRACT

The present invention concerns a metal powder for an additive manufacturing method, the metal powder comprising a nickel-based alloy comprising between 0.02% and 0.04% of carbon, between 18% and 22% of chromium, between 11% and 13% of cobalt, between 5% and 5.5% of niobium, between 3% and 3.5% of tantalum, between 3% and 3.4% of molybdenum, between 0.9% and 1.1% of titanium, between 0.4% and 0.6% of aluminium, between 0.003% and 0.005% of boron, not more than 0.5% of iron, not more than 0.1% of copper, not more than 0.1% of silicon, not more 10 than 0.05% of manganese, not more than 0.01% of phosphorus, not more than 0.01% of zirconium, not more than 0.004% of magnesium, not more than 0.003% of sulfur, not more than 0.025% of oxygen, not more than 0.018% of nitrogen and not more than 0.003% of hydrogen.

### FIELD OF THE INVENTION

The present invention concerns the field of additive manufacturing and, more particularly, alloys for the implementation of a powder bed-based additive manufacturing method.

### STATE OF THE ART

Many alloys are known for the implementation of powder bed-based additive manufacturing methods (LBM). It is specified that the term “alloy” for the implementation of a powder bed-based additive manufacturing method means a powder comprising a metal alloy. The powder is intended to be melted and then solidified during the implementation of a powder bed-based additive manufacturing method, to form a part.

Currently, many powders exist. However, most existing powders do not make it possible to obtain—after laser beam melting—a material suitable for use in a turbomachine. In particular, many powders do not make it possible to obtain a material resistant to a temperature of more than 650° C. However, a maximum resistance temperature of 650° C. is much too low for use in a turbomachine.

In this context, it is necessary to provide a powder comprising a metal alloy for a powder bed-based additive manufacturing method, which makes it possible to obtain a material retaining its tensile strength, creep strength and resistance to oxidation and corrosion, at least up to a temperature of 850° C., or even 1000° C., and which is weldable.

### DISCLOSURE OF THE INVENTION

According to a first aspect, the invention proposes a metal powder for an additive manufacturing method, the metal powder comprising a nickel-based alloy comprising between 0.02% and 0.04% carbon, between 18% and 22% chromium, between 11% and 13% cobalt, between 5% and 5.5% niobium, between 3% and 3.5% tantalum, between 3% and 3.4% molybdenum, between 0.9% and 1.1% titanium, between 0.4% and 0.6% aluminium, between 0.003% and 0.005% boron, maximum 0.5% iron, maximum 0.1% copper, maximum 0.1% silicon, maximum 0.05% manganese, maximum 0.01% phosphorus, maximum 0.01% zirconium, maximum 0.004% magnesium, maximum 0.003% sulphur, maximum 0.025% oxygen, maximum 0.018% nitrogen and maximum 0.003% hydrogen.

According to other advantageous and non-limiting characteristics:

The metal powder comprises a plurality of particles having a particle size in which at least 10% of the particles have a diameter comprised between 8 μm and 28 μm.

The metal powder comprises a plurality of particles having a particle size in which at least 50% of the particles have a diameter comprised between 10 μm and 45 μm.

The metal powder comprises a plurality of particles having a particle size in which at least 90% of the particles have a diameter comprised between 25 μm and 75 μm.

According to a second aspect, the invention proposes a method of powder bed-based additive manufacturing by laser melting of a powder according to the first aspect, the method making it possible to manufacture a part in a material obtained by laser melting of said powder.

According to other advantageous and non-limiting characteristics:

The laser emits a beam with a power comprised between 150 W and 350 W.

The laser is moved at a speed comprised between 900 mm/s and 2500 mm/s.

The laser emits a beam having a diameter comprised between 50 μm and 200 μm.

The laser melts the powder in strips, each strip having a width of between 2 mm and 15 mm.

Each melted strip overlaps at least one other strip by a width of between 0.05 mm and 0.15mm.

The laser melts the powder layers, each melted powder layer having a thickness comprised between 20 μm and 60 μm.

The method comprises a step of improving the structure of the material obtained by laser melting said powder, the step of improving the structure of the material comprising at least the following phases:
(b) first heat treatment at a temperature comprised between 1155° C. and 1175° C. for approximately 3 to 5 hours, followed by cooling to 595° C. in less than 23 minutes;
(c) second heat treatment, comprising:
holding at a temperature comprised between 890° C. and 910° C. for approximately 4 hours, followed by cooling to 775° C. at a rate of at least 55° C. per hour;
holding at a temperature comprised between 765° C. and 785° C. for approximately 4 hours, followed by cooling to 705° C. at a rate of at least 55° C. per hour;
holding at a temperature comprised between 695° C. and 715° C. for approximately 8 hours.

The step of improving the structure of the material further comprises a preliminary phase (a) of stress relief at a temperature comprised between 945° C. and 965° C., for approximately 2 hours.

The step of improving the structure of the material also comprises the following phases:
(d) fourth heat treatment at a temperature comprised between 945° C. and 965° C. for approximately 1 hour, followed by cooling to 650° C. in less than 23 minutes;
(e) fifth heat treatment, comprising:
holding at a temperature comprised between 750° C. and 770° C. for approximately 5 hours, followed by cooling to 700° C. at a rate of at least 55° C. per hour;
holding at a temperature comprised between 690° C. and 710° C. for approximately 8 hours;
maintaining at a temperature between 640° C. and 660° C. for approximately 1 hour.

According to a third aspect, the invention proposes a material obtained according to the second aspect, comprising a nickel-based alloy comprising between 0.02% and 0.04% carbon, between 18% and 22% chromium, between 11% and 13% cobalt, between 5% and 5.5% niobium, between 3% and 3.5% tantalum, between 3% and 3.4% molybdenum, between 0.9% and 1.1% titanium, between 0.4% and 0.6% aluminium, between 0.003% and 0.005% boron, maximum 0.5% iron, maximum 0.1% copper, maximum 0.1% silicon, maximum 0.05% manganese, maximum 0.01% phosphorus, maximum 0.01% zirconium, maximum 0.004% magnesium, maximum 0.003% sulphur, maximum 0.027% oxygen, maximum 0.018% nitrogen and maximum 0.003% hydrogen.

According to a fourth aspect, the invention proposes a turbomachine part made of the material according to the third aspect.

According to a fifth aspect, the invention proposes a turbomachine comprising at least one part according to the fourth aspect.

### DESCRIPTION OF THE FIGURES

Other characteristics, aims and advantages of the invention will emerge from the following description, which is purely illustrative and non-limiting, and which must be read with reference to the appended drawings in which:

FIG. 1 is a table detailing the preferred composition of the powder which is the subject of the invention.

FIG. 2 schematically represents a step of improving the structure of the material of a preferred embodiment of the method according to the invention.

FIG. 3 is a table detailing the composition of the material preferably obtained by the method according to the invention.

FIG. 4a is a photograph of the material preferably obtained by the method according to the invention before chemical etching.

FIG. 4b is a photograph in a first plane of the material preferably obtained by the method according to the invention.

FIG. 4c is a photograph in a second plane of the material preferably obtained by the method according to the invention.

### DETAILED DESCRIPTION OF THE INVENTION

### Metal Powder

According to a first aspect, the invention proposes a metal powder for a powder bed-based additive manufacturing method. The metal powder comprises a nickel-based alloy comprising at least carbon, chromium, cobalt, niobium, tantalum, molybdenum, titanium, aluminium, boron, iron, copper, silicon, manganese, phosphorus, zirconium, magnesium, sulphur, oxygen, nitrogen and hydrogen.

In the remainder of the present description, the “amounts” or “contents” will be expressed in terms of mass (i.e., mass of said element over the total mass of the alloy).

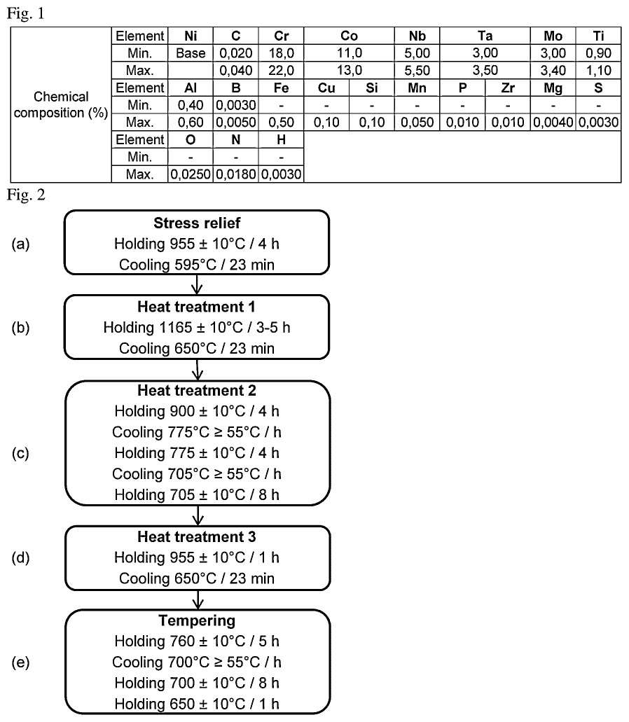

According to a particular arrangement, such as detailed in the table of FIG. 1, the nickel-based alloy comprises between 0.02% and 0.04% carbon, between 18% and 22% chromium, between 11% and 13% cobalt, between 5% and 5.5% niobium, between 3% and 3.5% tantalum, between 3% and 3.4% molybdenum, between 0.9% and 1.1% titanium, between 0.4% and 0.6% aluminium, between 0.003% and 0.005% boron, maximum 0.5% iron, maximum 0.1% copper, maximum 0.1% silicon, maximum 0.05% manganese, maximum 0.01% phosphorus, maximum 0.01% zirconium, maximum 0.004% magnesium, maximum 0.003% sulphur, maximum 0.025% oxygen, maximum 0.018% nitrogen and maximum 0.003% hydrogen.

Thus, the powder which is the subject of the invention comprises a nitrogen, oxygen and sulphur content suitable for use in a powder bed-based additive manufacturing method.

It is specified that a suitable content means a content which makes it possible to obtain a material having the required thermomechanical characteristics after melting the powder by a laser beam. Indeed, metal powders are known for foundry work (or metallurgy in general) which contain substantially the same list of elements, but their particle size and sulphur, nitrogen and oxygen levels are not suitable.

In particular, each of the sulphur, nitrogen and oxygen is present in said alloy in a proportion less than a maximum proportion for additive manufacturing, advantageously 0.025%, even more advantageously 0.003% for sulphur and 0.018% for nitrogen.

Advantageously, the powder also has a particle size suitable for use in a powder bed-based additive manufacturing method.

Similarly, by suitable particle size is understood a particle size allowing for good deposition of a layer of powder in the bed.

Thus, according to a particular arrangement, 10% of the particles have a diameter comprised between 8 μm and 28 μm, 50% of the particles have a diameter comprised between 10 μm and 45 μm and 90% of the particles have a diameter comprised between 25 μm and 75 μm.

Preferably, 10% of the particles have a diameter comprised between 10 μm and 25 μm, 50% of the particles have a diameter comprised between 15 μm and 40 μm and 90% of the particles have a diameter comprised between 30 μm and 70 μm.

This specific particle size makes it possible very advantageously to combine optimum compactness of the powder when it is used in a powder bed-based additive manufacturing method, while having optimum flowability and minimizing melting stresses (this reduces the risk of cracking of the material obtained by an additive manufacturing method).

It is specified that this particle size is preferably obtained via an atomization method, which ensures the morphology of each particle while limiting the risks of contamination of the powder by foreign material.

### Additive Manufacturing Method

According to a second aspect, the invention relates to a method for powder-based additive manufacture by laser melting of a powder according to the invention.

In a known way, the method uses an additive manufacturing machine, in which a system deposits a bed of powder and emits, for example, a laser beam to melt and consolidate a layer of a material being manufactured.

In more detail, a bed of powder a few tens of microns thick is deposited on a tray, usually by means of a scraper. Then it is melted locally.

The plate is lowered and the deposition/melting cycle is repeated until the part is built.

Conventionally, the laser beam illuminates a defined surface which is usually called a “spot”.

Generally, the laser beam is enveloped in a neutral gas jet. Preferably, in the context of the method which is the subject of the invention, argon or dinitrogen will be used.

In a manner specific to the method according to the invention, the laser emits a beam with a power of between 150 W and 300 W.

In addition, the laser is moved at a speed comprised between 900 mm/s and 2500 mm/s.

Preferably, the laser emits a beam having a diameter comprised between 50 μm and 200 μm. It is specified that, by beam diameter, it is understood that the spot, i.e., the surface illuminated by the beam, has a diameter comprised between 50 μm and 200 μm.

As indicated above, in a known manner, the laser beam is moved in strips and by superimposed layers in order to consolidate the material being manufactured.

Preferably, each strip has a width comprised between 2 mm and 15 mm.

In addition, the melted strips may overlap over a width comprised between 0.05 mm and 0.15 mm.

In addition, each layer of melted powder may have a thickness comprised between 20 μm and 60 μm.

At this stage, the raw molten alloy does not yet have the expected mechanical properties (especially with regard to creep resistance and fatigue).

For this, according to an advantageous arrangement, at the end of additive manufacturing, the method comprises a step of improving the structure of the material, by various heat treatments. Each heat treatment ends with air cooling (for example under argon protection).

With reference to FIG. 2, this step may include the following phases:

It begins with an optional stress relief phase (a), called interoperation treatment, at a temperature comprised between 945° C. and 965° C., for approximately 2 hours (to within 20%).

This treatment makes it possible to homogenize the material and to eliminate Laves phases, before the main phase of the heat treatment.

This main phase, known as the “state of use”, makes it possible to obtain the metallurgical health necessary for the use of the material for turbomachine parts, and includes a succession of heat treatments.

First, (b) a first heat treatment at a temperature comprised between 1155° C. and 1175° C., for approximately 3 to 5 hours (to within 20%), followed by cooling to 595° C. in less than 23 minutes, then in air.

The state of use phase then comprises (c) a second a second heat treatment which itself comprises three sub-parts: heating to a temperature comprised between 890° C. and 910° C. for approximately 4 hours (to within 10 minutes), followed by cooling to 775° C. at a rate of at least 55° C. per hour; then holding at a temperature comprised between 765° C. and 785° C. for approximately 4 hours (to within 10 minutes), followed by cooling to 705° C. again at a rate of at least 55° C. per hour; and, finally, holding at a temperature comprised between 695° C. and 715° C. for 8 hours (to within 10 minutes). There is still a final cooling in air.

After this state of use phase, a particle size of around 2 to 8 ASTM is obtained, which allows a good compromise between mechanical properties (especially between creep and fatigue). The heat treatments make it possible to obtain HRC hardness between 15 and 60 HRC and properties at the expected and interesting levels for the targeted parts. A slight anisotropy typical of LBM can be noted, which is not problematic for the properties of the alloy; see FIGS. 4a, 4b and 4c which represent the particles in the material obtained respectively before etching, after etching along an XY plane of the turbomachine, and after etching along an XZ plane of the turbomachine.

The metallurgical health obtained incorporates indications of less than 0.8 mm and a porosity rate of less than 2% that allow excellent mechanical properties.

In the case of welding with another alloy, for example Inconel 718, it is possible to apply an additional post-welding phase to maintain the two materials at the best of their respective properties.

This optional phase comprises (d) a third heat treatment at a temperature comprised between 945° C. and 965° C., for approximately 1 hour (to within 20%), followed by cooling to 650° C. in less than 23 minutes. There is still a final cooling in air.

Preferably, the post-welding phase further comprises (e) a fourth heat treatment, referred to as tempering, again comprising three sub-parts: holding at a temperature comprised between 750° C. and 770° C. for approximately 5 hours (to within 10 minutes), followed by cooling to 700° C. at a rate of at least 55° C. per hour; then holding at a temperature comprised between 690° C. and 710° C., for approximately 8 hours (to within 10 minutes) followed by cooling in air, then a last holding at a temperature comprised between 640° C. and 660° C., for approximately 1 hour (to within 10 minutes), ending with cooling in air.

Note that a thermomechanical treatment phase (application of a high temperature and pressure) can be done at the very beginning of the step of improving the structure of the material, in particular of the hot isostatic pressing (HIP) type. This treatment reduces any microcracks that may be present in the material after additive manufacturing.

### Material Obtained

According to a third aspect, the invention concerns a material obtained according to the method of the invention.

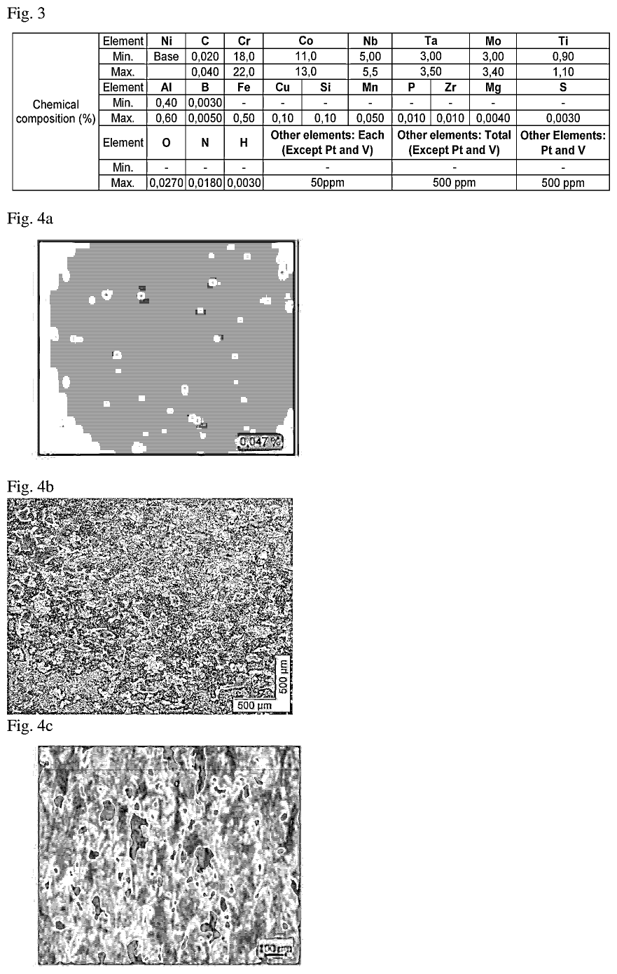

According to a particular arrangement, such as detailed in the table of FIG. 3, the material obtained comprises a nickel-based alloy comprising between 0.02% and 0.04% carbon, between 18% and 22% chromium, between 11% and 13% cobalt, between 5% and 5.5% niobium, between 3% and 3.5% tantalum, between 3% and 3.4% molybdenum, between 0.9% and 1.1% titanium, between 0.4% and 0.6% aluminium, between 0.003% and 0.005% boron, maximum 0.5% iron, maximum 0.1% copper, maximum 0.1% silicon, maximum 0.05% manganese, maximum 0.01% phosphorus, maximum 0.01% zirconium, maximum 0.004% magnesium, maximum 0.003% sulphur, maximum 0.027% oxygen, maximum 0.018% nitrogen and maximum 0.003% hydrogen.

This time, the material may include other trace chemical elements, in particular:
Platinum and/or vanadium in an amount of maximum 500 ppm;
Elements other than those listed before in an amount of maximum 50 ppm;
It is understood that the elements other than those listed above (also other than platinum and vanadium) have a total content of maximum 500 ppm.

The presence of these elements is generally due to external contamination during the handling of the powder.

It is specified that the variation in the oxygen content, relative to the composition of the powder, is due to oxygen capture during the execution of the additive manufacturing method.

### Turbomachine Component and Turbomachine

According to another aspect, the invention relates to a turbomachine part manufactured according to the method of the invention, i.e., made of said material as described above.

According to another aspect, the invention concerns a turbomachine comprising at least one part according to the invention.

1. A metal powder for an additive manufacturing method. the metal powder comprising a nickel-based alloy comprising between 0.02% and 0.04% carbon, between 18% and 22% chromium, between 11% and 13% cobalt, between 5% and 5.5% niobium, between 3% and 3.5% tantalum, between 3% and 3.4% molybdenum, between 0.9% and 1.1% titanium, between 0.4% and 0.6% aluminium, between 0.003% and 0.005% boron, maximum 0.5% iron, maximum 0.1% copper, maximum 0.1% silicon, maximum 0.05% manganese, maximum 0.01% phosphorus, maximum 0.01% zirconium, maximum 0.004% magnesium, maximum 0.003% sulphur, maximum 0.025% oxygen, maximum 0.018% nitrogen and maximum 0.003% hydrogen.

2. The metal powder according to claim 1 comprising a plurality of particles having a particle size in which at least 10% of the particles have a diameter comprised between 8 μm and 28 μm.

3. The metal powder according to claim 1, comprising a plurality of particles having a particle size in which at least 50% of the particles have a diameter comprised between 10 μm and 45 μm.

4. The metal powder according to claim 1, comprising a plurality of particles having a particle size in which at least 90% of the particles have a diameter comprised between 25 μm and 75 μm.

5. A method of powder bed-based additive manufacturing by laser melting of the metal powder according to claim 1, the method comprising a step of obtaining a material by a laser melting of the metal powder by a laser.

6. The method of claim 5, wherein, during the step of obtaining the material:
the laser emits a beam of power comprised between 150 W and 350 W,
the laser is moved at a speed comprised between 900 mm/s and 2500 mm/s,
the laser emits a beam having a diameter comprised between 50 μm and 200 μm,
the laser melts the metal powder in strips, each strip having a width comprised between 2mm and 15 mm,
each melted strip overlaps at least one other strip, over a width comprised between 0.05 mm and 0.15 mm,
the laser melts metal powder layers, each melted metal powder layer having a thickness comprised between 20 μm and 60 μm.

7. The method according to claim 5, comprising a step of improving a structure of the material obtained by the laser melting of the metal powder, the step of improving the structure of the material comprising at least the following phases:
(b) a first heat treatment at a temperature comprised between 1155° C. and 1175° C. for approximately 3 to 5 hours, followed by cooling to 595° C. in less than 23 minutes;
(c) a second heat treatment, comprising:
holding at a temperature comprised between 890° C. and 910° C. for approximately 4 hours, followed by cooling to 775° C. at a rate of at least 55° C. per hour;
holding at a temperature comprised between 765° C. and 785° C. for approximately 4 hours, followed by cooling to 705° C. at a rate of at least 55° C. per hour; and
holding at a temperature comprised between 695° C. and 715° C. for approximately 8 hours.

8. The method according to claim 7, wherein the step of improving the structure of the material further comprises a preliminary phase (a) of stress relief at a temperature comprised between 945° C. and 965° C., for approximately 2 hours.

9. The method according to claim 7, wherein the step of improving the structure of the material further comprises the steps of:
(d) a third heat treatment at a temperature comprised between 945° C. and 965° C. for approximately 1 hour, followed by cooling to 650° C. in less than 23 minutes;
a fourth heat treatment, comprising:
holding at a temperature comprised between 750° C. and 770° C. for approximately 5 hours, followed by cooling to 700° C. at a rate of at least 55° C. per hour;
holding at a temperature comprised between 690° C. and 710° C. for approximately 8 hours; and
maintaining at a temperature between 640° C. and 660° C. for approximately 1 hour.

10. A material obtained according to the method according to claim 6, comprising a nickel-based alloy comprising between 0.02% and 0.04% carbon, between 18% and 22% chromium, between 11% and 13% cobalt, between 5% and 5.5% niobium, between 3% and 3.5% tantalum, between 3% and 3.4% molybdenum, between 0.9% and 1.1% titanium, between 0.4% and 0.6% aluminium, between 0.003% and 0.005% boron, maximum 0.5% iron, maximum 0.1% copper, maximum 0.1% silicon, maximum 0.05% manganese, maximum 0.01% phosphorus, maximum 0.01% zirconium, maximum 0.004% magnesium, maximum 0.003% sulphur, maximum 0.027% oxygen, maximum 0.018% nitrogen and maximum 0.003% hydrogen.

11. A turbomachine part made of the material of claim 10.

12. A turbomachine comprising at least one part according to claim 11.
